(19) United States
(12) Patent Application Publication
(10) Pub. No.: US 2008/0036200 A1
(43) Pub. Date: Feb. 14, 2008

(54) Visco Elastic Damping In A Piping System

(75) Inventors: Claes Fredo, Lerum (SE); Jan Wigaard, Osteras (NO)

Correspondence Address: VENABLE LLP, P.O. BOX 34385, WASHINGTON, DC, 20043-9998, US

(73) Assignees: Vetco Aibel AS, Billingstad (NO); AF-Ingemansson AB, Goteborg (SE)

(21) Appl. No.: 11/596,927

(22) PCT Filed: May 18, 2005
(86) PCT No.: PCT/IB05/01351

§ 371 Date: Nov. 17, 2006

(30) Foreign Application Priority Data
May 18, 2004 (NO) 20042050

(51) Int. Cl. F16L 55/02

(52) U.S. Cl. 285/49

(57) ABSTRACT

A piping system for visco elastic damping, which system oscillates with high frequency, small amplitude oscillations. The system includes one or more autonomous visco elastic dampers that includes one or more layers of visco elastic damping material fixedly bonded between stiff members. The visco elastic dampers may be provided with a temperature controlling element.

### FIELD OF THE INVENTION AND PRIOR ART

The present invention relates to a piping system for visco elastic damping, which system oscillates with high frequency, small amplitude oscillations.

In particular, the invention has been developed in connection with the growing problem of acoustic oscillations in piping structures or systems used for transport of fluids. The problem may rise to serious dimensions if the pipes and associated pipe and structural details have natural frequencies which coincide with the excitation frequency in such a way that resonance arises. Additional amplification may arise if the natural frequency of the pipes and associated pipe and structural details, such as support arrangements, attached valves and measuring devices etc., coincides with acoustic natural frequencies such that fluid-structure interaction occurs. Such types of resonance have in some cases caused ruptures in the affected piping systems with leakage and subsequent risk of explosions as a consequence.

Attempts to solve the problem by adding additional stiffening components have little effect, as such stiffening only changes the natural frequencies of the system and does not remove either the excitation or the response energy. As the excitation spectrum is relatively broad with typical values from above 50 Hz and multiples thereof, and the base excitation frequency varies with pressure and speed, it is extremely difficult to significantly improve the situation by the use of stiffening components alone.

For a suspended vibrating element there are four different physical forces acting directly on the element: gas pressure, inertial forces (mass acceleration), spring forces (stiffness-displacement) and damping forces. It is these forces which govern the response energy.

Damping forces have the characteristic that they take energy out of the system. Visco elastic damping gives forces proportional to velocity. Secondary damping may occur through friction in the supporting arrangement and air stream damping. Without damping, a free oscillation will continue to infinity and the response at resonance will increase to infinity. Installing stiffening components made of, for example, steel will only effect the stiffness and inertia. Metal piping systems have therefore little natural damping, which is partly the reason that resonance becomes a problem.

Traditional dampers, such as mass dampers, snubbers, hydraulic dampers, plasma dampers and “Gerb”-dampers, do not function well at the type of load in question, namely high frequency, broad frequency spectra and small amplitudes.

A possible method of damping oscillations is visco elastic damping, but there is hitherto no known method for applying this form of damping to piping systems which are located in an environment with temperature variations beyond the working range of the visco elastic material and in which the vibrations have very small amplitudes. The latter has the consequence that it is difficult to achieve the necessary deformation in the damping material.

Visco elastic damping of pipelines which are excited and set into oscillation by wind forces, is already public knowledge, see for example U.S. Pat. No. 5,193,644. The method of damping disclosed in this US patent includes suspension of mass elements on the pipeline by means of elastic elements which are subjected to shear forces.

Arrangements where visco elastic damping has been used to damp out vibrations in beams, for example in buildings, are also known. In such arrangements damping material has been placed between two stiff components or structures, see for example U.S. Pat. No. 4,039,050. Also in these cases the aim is to damp oscillations caused by external effects and the damper is arranged between a fixed structure and the end of an appropriate beam.

### SUMMARY OF THE INVENTION

The present invention is primarily aimed at damping oscillations in fluid conducting pipes or pipe structures in which harmful and/or destructive acoustic oscillations may occur in the high frequency ranges, typically from 50 to 1000 Hz and with small amplitudes, typically less than 0.1 mm, without strictly limiting the present invention to these frequency and amplitude ranges.

One main object of the present invention is to provide a piping system for visco elastic damping which in a practical and effective way substantially counteracts the internal loads, such as flow induced pressure variations, in the piping system, in order to among other things increase the safety.

The main object of the invention is achieved by means of the piping system as initially defined, characterized in that the system comprises one or more autonomous visco elastic damper links of the type which comprises one or more layers of visco elastic damping material fixedly bonded between a first stiff member and a second stiff member.

According to a preferred embodiment of the invention the visco elastic damper or damper links is/are stiffly joined between mutually connected pipe sections (pipes) or pipe details in the piping system.

According to another preferred embodiment of the invention a visco elastic damper of the said type is arranged for damping of oscillations in the longitudinal direction of a first pipe (11), and that two visco elastic dampers of the said type are arranged for damping of oscillations across said longitudinal direction of said pipe.

According to another preferred embodiment of the invention two visco elastic dampers are arranged mutually rotated 90 degrees in the longitudinal direction and fastened between the pipe legs of a pipe bend.

According to another preferred embodiment of the invention the respective visco elastic damper is provided with a temperature controlling element and that the visco elastic damping material and the temperature controlling element are surrounded by an insulation layer which is encapsulated by a protective means, such as a protective jacket. By using temperature controlled visco elastic dampers the necessary prerequisite (temperature) conditions for each individual visco elastic damper in question may be secured.

A fundamental idea of the present invention is to damp oscillations of a pipe or pipe detail(s) in a piping system by means of one or more autonomous, i.e. self-damping, visco elastic dampers or damper links by connecting two different parts of the piping system with each other and/or between the piping system or structure and another free standing object, such as a supporting structure, via one or more of said dampers or damper links, which dampers or damper links are stiffly attached to the pipe or pipe detail(s) to be damped and the piping structure. Thus, the damping of the pipe or pipe detail(s) substantially limit the relative displacements between the two different parts of the piping system, thereby limiting the oscillating material strain which is what causes fatigue failure.

The damper or damper link has a limited stroke length in comparison with other types of dampers, e.g. visco elastic Gerb dampers and is therefore limited to damping applications with small relative deformation due to variation in static loads or temperature loads. A typical non-limiting scope of application is to arrange the damper or damper link between a support location on the main pipe structure and a pipe object to be damped.

The use of discrete damping elements makes it possible to increase, structural damping of oscillations in piping systems for liquids and gases locally to individual parts or sections of the system. The discrete dampers may be regarded as components attached between two substructures, which can be structurally connected to other neighbouring surfaces. The active parts of the visco elastic dampers will transform a substantial amount of the vibration-deformation energy into heat during the course of each vibration or oscillation cycle and thereby damping the vibrations. The present invention solves the above-mentioned types of oscillation problems in piping systems through the targeted introduction of a practical form of structural damping, instead of modifying the stiffness and/or inertia of the system as in the prior art.

The loss factor of a damping material is a measure for how much of the oscillation energy that transforms to heat in the damping material. A high loss factor means that the displacement damper will transfer a substantial part of the oscillation energy to heat for each oscillation cycle. For visco elastic damping in a piping system, this is an irreversible process. The energy loss to the surroundings is due to the hysteresis in the tension-strain curve in the damping material. The most effective hysteresis is obtained by letting a layer of damping material experience shear deformations.

Some damping materials, such as for example visco elastic damping materials, have the characteristic that the loss factor is dependent on both the surrounding temperature and vibration frequency, see FIG. 1. The temperature dependency of the loss factor is often stronger than its dependency on frequency. When a visco elastic material is used for damping of oscillations, it is therefore necessary to keep the material within a given temperature range to obtain the optimal performance. This temperature range is called the working range (or transition region) of the visco elastic damping material, which is indicated with a double arrow in FIG. 1. For temperatures below this range the visco elastic material becomes fragile and glass-like. For temperatures above the optimal temperature range the material becomes soft and rubber-like.

Further preferred embodiments and features of the present invention will appear from the independent claims and the subsequent description.

### BRIEF DESCRIPTION OF THE DRAWINGS

The invention will now be explained in more detail with reference to the appended drawings which show examples of embodiments, and where:

FIG. 1 shows module of elasticity and loss factor for a visco elastic material as a function of temperature,

FIG. 2 schematically shows a cross section of a visco elastic damper with an optional temperature control, according to one embodiment of the invention,

FIG. 3 shows visco elastic dampers between a pipe and an attachment, according to another embodiment of the invention,

FIG. 4 schematically shows a cross section perpendicular to the longitudinal cross section as shown in FIG. 3,

FIG. 5 shows visco elastic dampers placed between two attachments, and between one of the attachments and a pipe, according to another embodiment of the invention,

FIG. 6 shows a visco elastic damper mounted in a 180 degree pipe bend, according to another embodiment of the invention,

FIG. 7 shows a cross section along the line A-A in FIG. 6,

FIG. 8 shows a cross section along the line B-B in FIG. 6,

FIG. 9 shows visco elastic dampers mounted in a 90 degree pipe bend, according to another embodiment of the invention,

FIG. 10 shows a ring type damper, according to another embodiment of the invention,

FIG. 11 shows a cut along the line C-C in FIG. 10,

FIG. 12 shows a subsea assembly of visco elastic dampers according to another embodiment of the invention, and

FIGS. 13 to 23 show different types of adapters.

### DETAILED DESCRIPTION OF PREFERRED EMBODIMENTS OF THE INVENTION

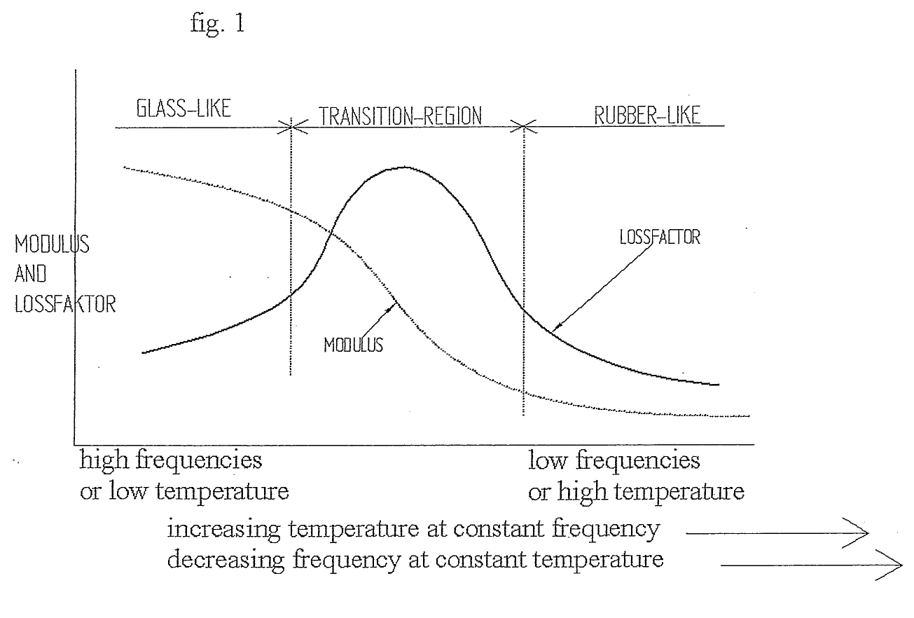

FIG. 1 shows how the modulus of elasticity and loss factor for a visco elastic material vary both as a function of increasing surrounding temperature when vibration frequency is held constant and decreasing vibration frequency when surrounding temperature is held constant, with the visco elastic materials working temperature given as the temperature range between glass-like and rubber-like behaviour states.

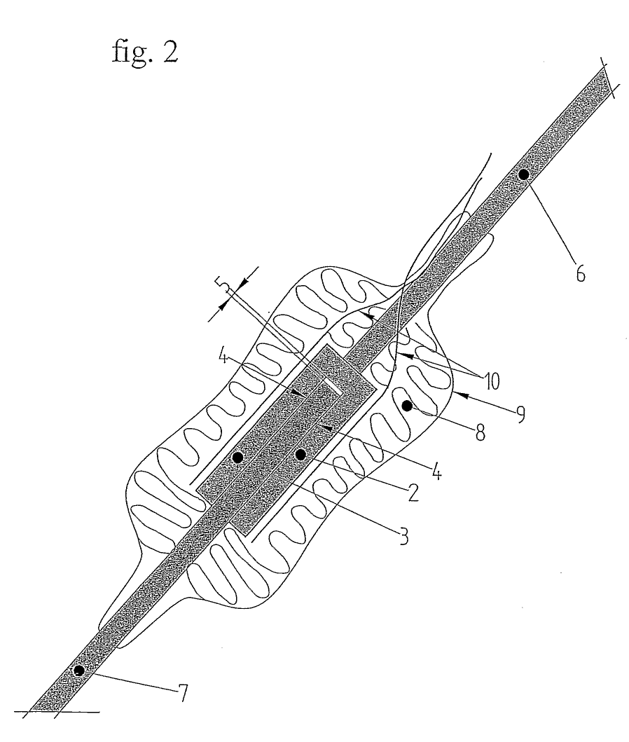

FIG. 2 shows a schematic cross section of a visco elastic damper in a cross section, which damper constitutes a damper link connected between two different parts of a piping system and/or between the piping system and another free standing object. The damper link comprises a first stiff member comprising two spaced-apart stiff plate elements 2 and 3 forming a U-shape cross section, and an end part of a strut 6 or the like connected thereto so as to form a flat fork-like (flat yoke) structure at the one end, and a second stiff member in the form of an end part of a flat strut 7 or the like, or a plate element fixedly attached to the end part of the flat strut 7 or the like, which extends between the two plate elements 2,3 so as to be disposed within said plate elements 2,3. There is sandwiched between both the plate elements 2,3 and the respective faces of the end part of the flat strut 7 (or the plate element) a thin shear layer of visco elastic material 4 which are fixedly bonded to the inner faces of the two plate elements 3,4 and the opposite faces of the end part of the strut 7 (or the plate element). The deformation of the thin layer of visco elastic material 4 at maximum amplitudes in both directions of oscillation is indicated at reference number 5 (greatly exaggerated). The two plates 2,3 are connected by and to a strut 6.

The damper is provided with a surrounding thermal insulation 8, which is encapsulated by a water proof layer 9. An electric heating element comprising electrical heating cables 10 which are embedded in the insulation 8 at the damper 2,3,4 itself. Alternatively, a corresponding electric cooling element may be used. Such a damper can be maintained at a specific temperature or within a specific temperature range through the use of the temperature controlled heating element. It is within the knowledge of a person skilled in the art to modify the temperature controlling arrangement, i.e. the heating/cooling elements, the control system and the placement of possible sensors, to maintain a desired temperature range for the damper in a given working environment. For example, other kinds of self controlling heating/cooling elements or cables may be used. Further, a temperature sensor may for example be arranged within or in the immediate proximity of the visco elastic material.

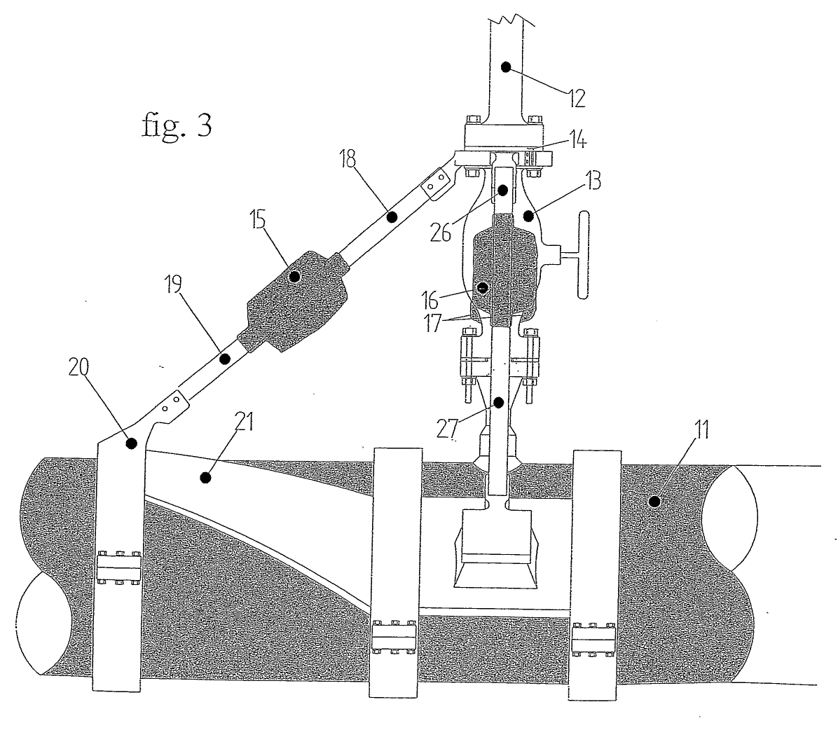

FIGS. 3 and 4 show an embodiment according to the invention comprising which comprises visco elastic dampers or damper links arranged between a pipe 11 and an attachment (pipe) 12, comprising of a valve 13 with a flange 14. As shown in the figures three dampers or damper links 15,16 and 17 are installed in the piping system. The dampers are of the type with temperature control as shown in FIG. 2. The damper or damper link 15 for damping oscillations in the longitudinal direction of the pipe is attached between the pipe 11 and the attachment/valve 12/13 by means of struts 18 and 19 respectively. The struts 18, 19 correspond to the struts 6 and 7 in FIG. 2. The strut 18 is stiffly attached to the valve flange 14. The strut 19 is stiffly attached to a collar 20, which is a part of an adapter 21 placed on and around the pipe 11. The two cross-wise mounted dampers or damper links 16, 17 for damping oscillations in the cross direction of the pipe are attached to the valve flange 14 and the adapter 21 by means of the struts 24, 25 and 26, 27 respectively in a similar manner to the attachment of the damper link 15. The struts 24-27 correspond to the struts 6 and 7 in FIG. 2.

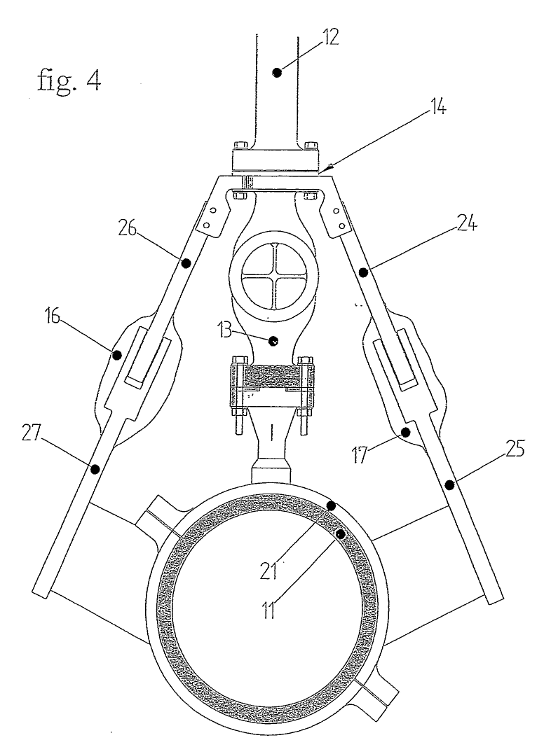

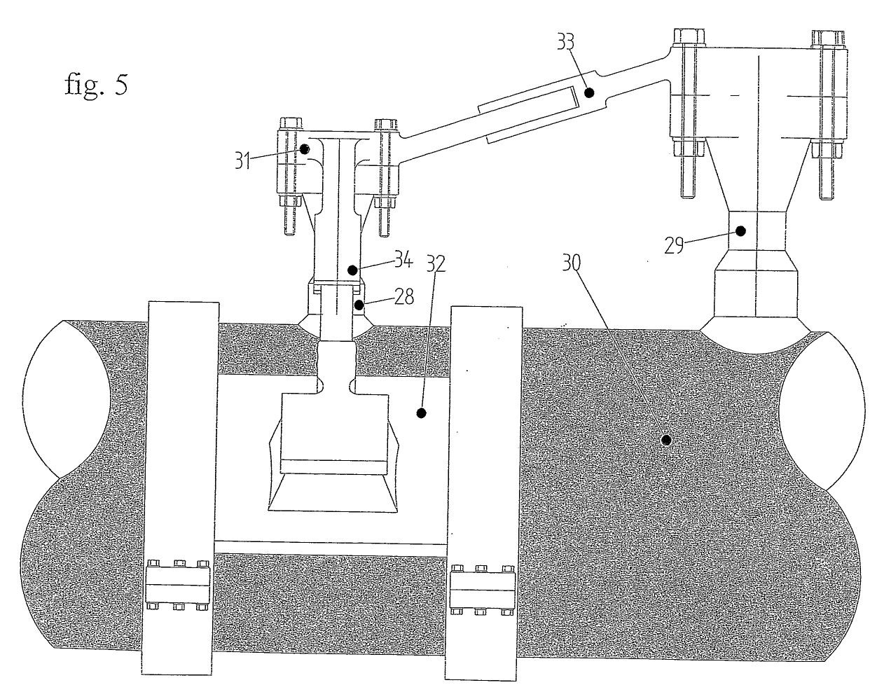

FIG. 5 shows an embodiment according to the invention comprising three visco elastic dampers or damper links in a piping system. Two cross-wise mounted dampers or damper links (one 34 of which can be seen in the figure) are mounted on a pipe 30 between a blind flange 31 on attachment 28 and a yoke 32 respectively, as in the embodiment according to FIG. 4. The other damper or damper link 33 (schematically shown in a cross section and without temperature control) is attached between the blind flange 31 and the attachment 29.

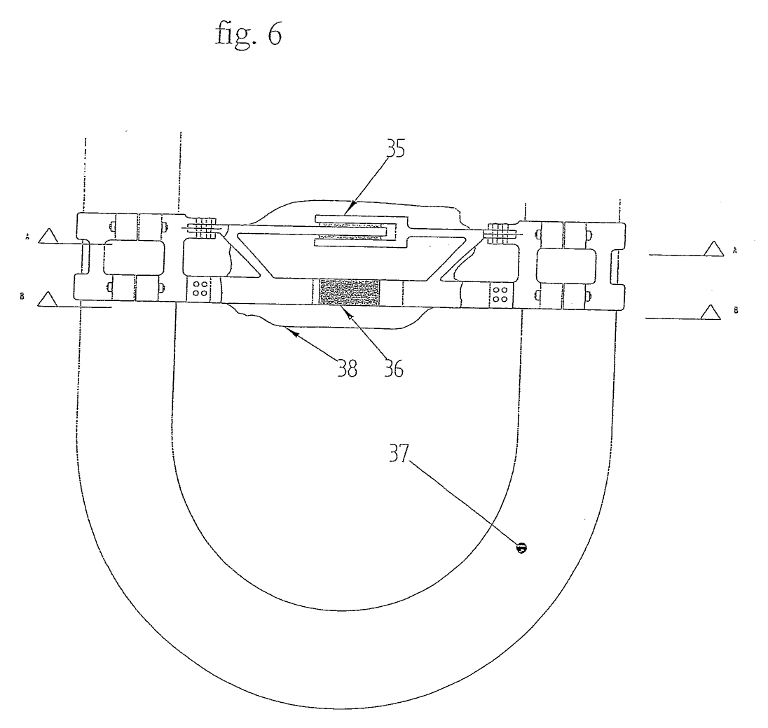

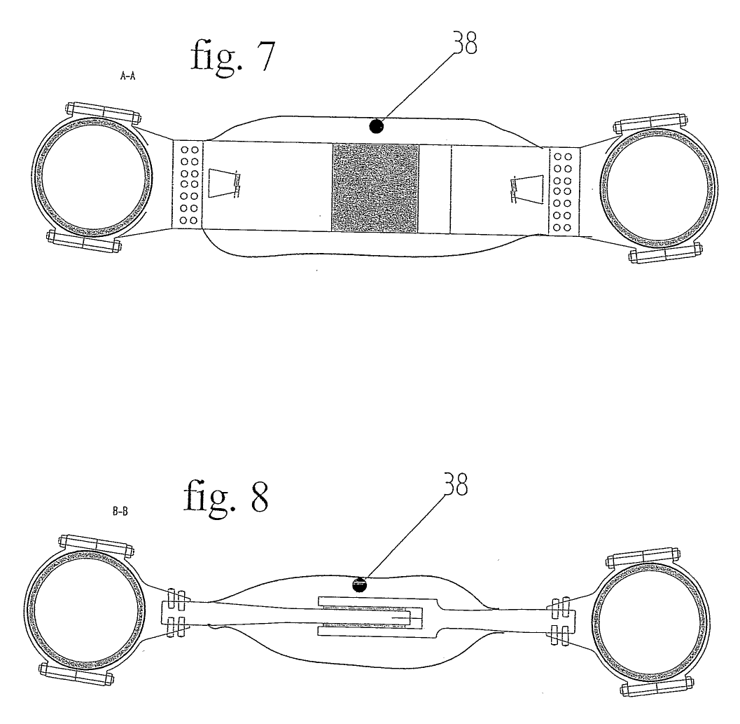

FIG. 6 shows a further embodiment according to the invention comprising two dampers or damper links 35 and 36 mounted between the legs of a 180 degree pipe bend 37. The two dampers 35,36 are arranged in parallel, but mutually rotated 90 degrees. It is intended that the dampers shall be temperature controlled and hence be provided with thermal insulation 38, see also FIG. 2 for details. In the FIGS. 7 and 8, the dampers 35,36 are schematically shown in a cross section as indicated with lines A-A and B-B in FIG. 6.

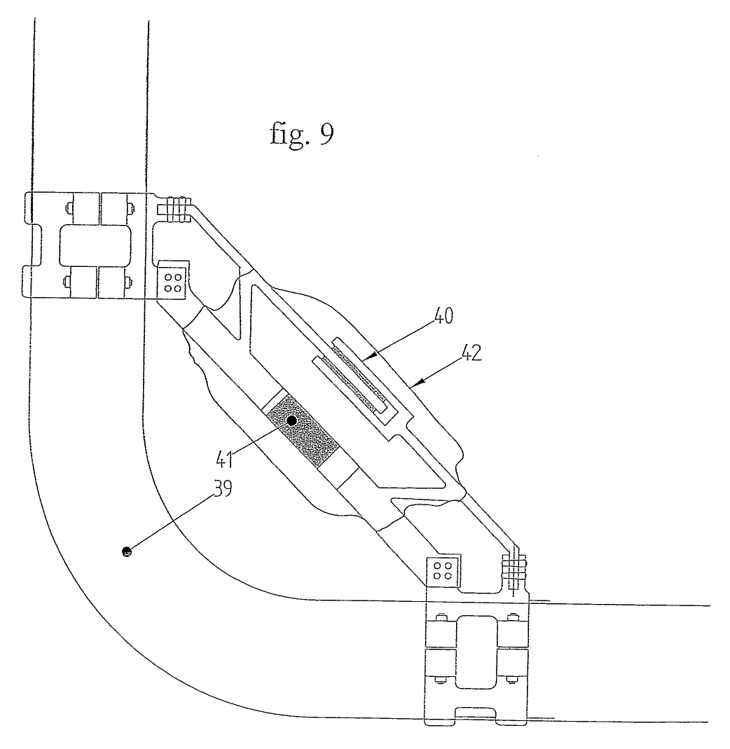

A similar embodiment for a 90 degree pipe bend 39 is shown in FIG. 9, where the schematically shown dampers or damper links are denoted by 40 and 41 and it is also here indicated that they are insulated and temperature controlled 42.

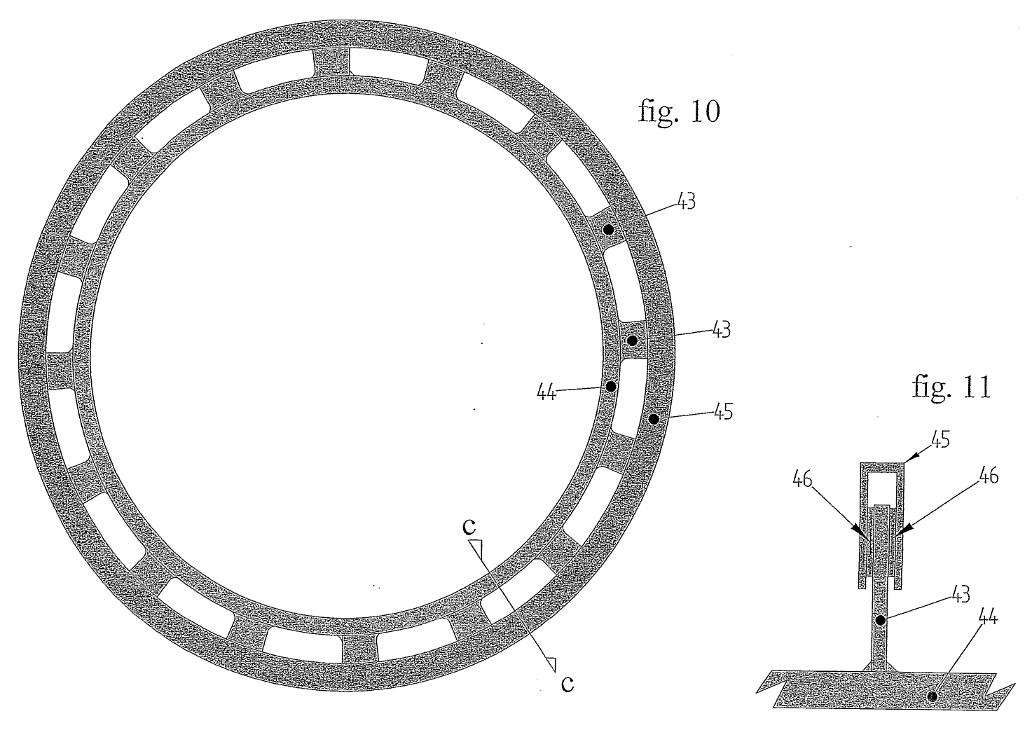

FIGS. 10 and 11 show a ring type design of a damper wherein stiff plate elements 43 are attached to a pipe 44 which is to be damped. A ring element 45 with a U-shaped cross section is placed around the pipe 44. As shown in the figures, the ring element 45 is clamped around the plates 43 protruding from the pipe 44, and visco elastic damping material 46 is arranged between the plates 43 and the ring element 45, see detail in FIG. 11. This damper embodiment is designed to damp pipe wall oscillation modes. Temperature control may be utilized, but is not shown in the figure.

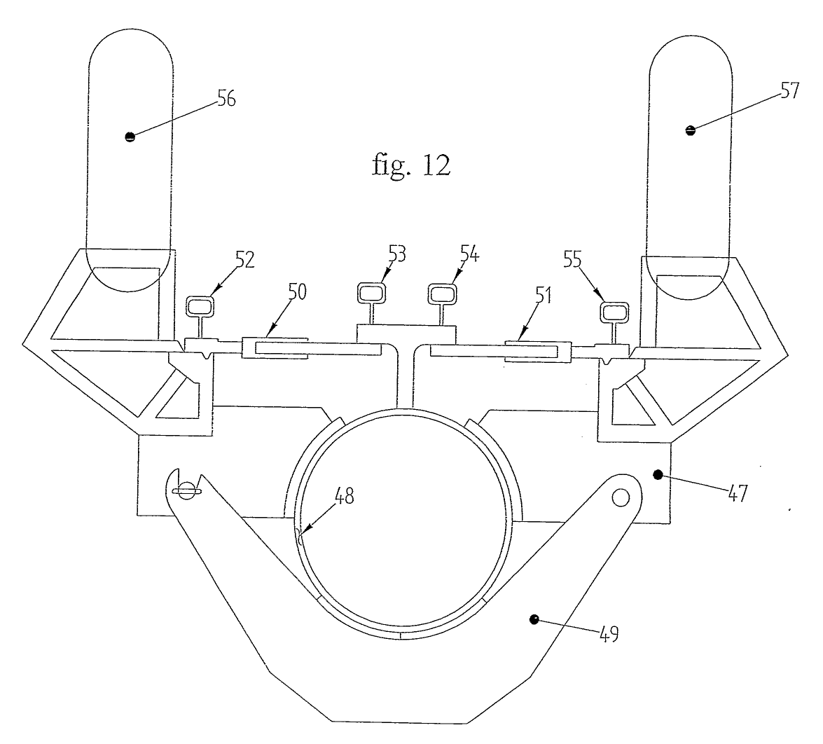

FIG. 12 shows a possible embodiment of according to the invention in a subsea assembly. A yoke 47 is lowered down and placed on a pipe 48. The yoke 47 is secured in place with a collar 49 or the like, before the visco elastic dampers or damper links 50 and 51 are mounted with ROV (Remotely Operated Vehicle) bolts 52-55. Two buoyancy tanks 56 and 57 are shown in the figure, but may be excluded.

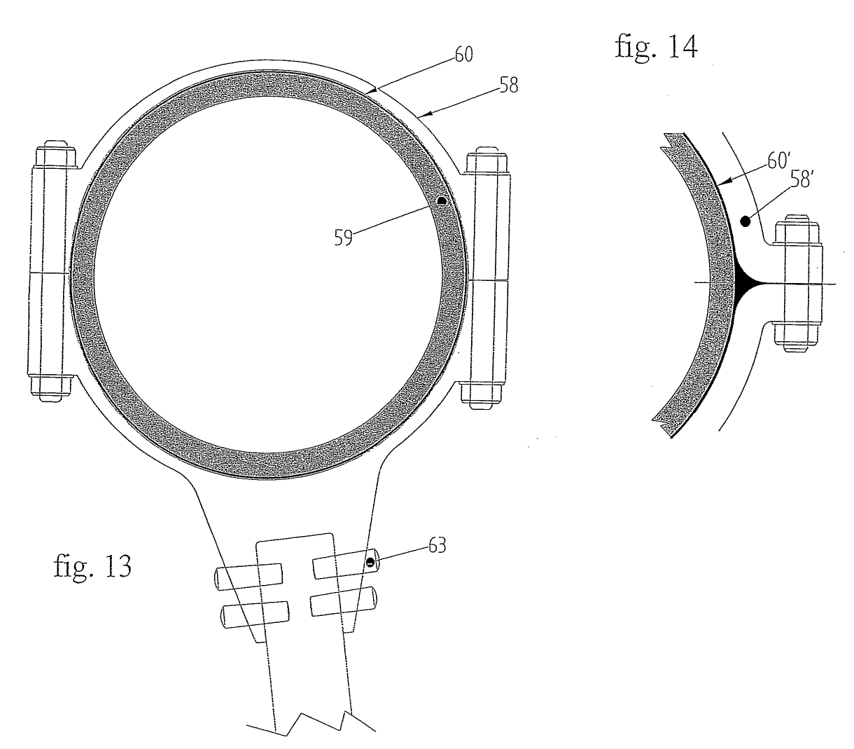

The method of attaching the visco elastic dampers or damper links is important. In addition to some of the above described figures showing an adapter, the FIGS. 13 to 23 show different additional types of adapters which can be used to achieve the attachments of the dampers or damper links to a pipe in a piping system. It is important that the individual visco elastic dampers or damper links are fastened to the adapters in such a way that displacement arises in the damper or damper link and not in the attachment to the pipe such that the energy taken out from the piping system is through the deformation in the damper or damper link. However, it is within the scope of the present invention that one or more visco elastic dampers could also be attached between a pipe and an adapter, for example in the form of a collar, fixed to the pipe, via the visco elastic damper in order to damped out vibrations directly associated with the pipe wall.

FIG. 13 shows an adapter with a clamp ring 58 which is fastened to a foundation, that is the pipe 59, with glue 60. The clamp ring 58 is pre-tensioned around the pipe 59 by means of bolts 61. One strut 62, for example corresponding to the strut 25 or 27 in FIGS. 3 and 4, is fastened to the clamp ring 58 with a specially fabricated component with conical pins 63. FIG. 14 shows an alternative of a clamp ring 58 where the glue 60′ is applied into the gap in the clamp ring.

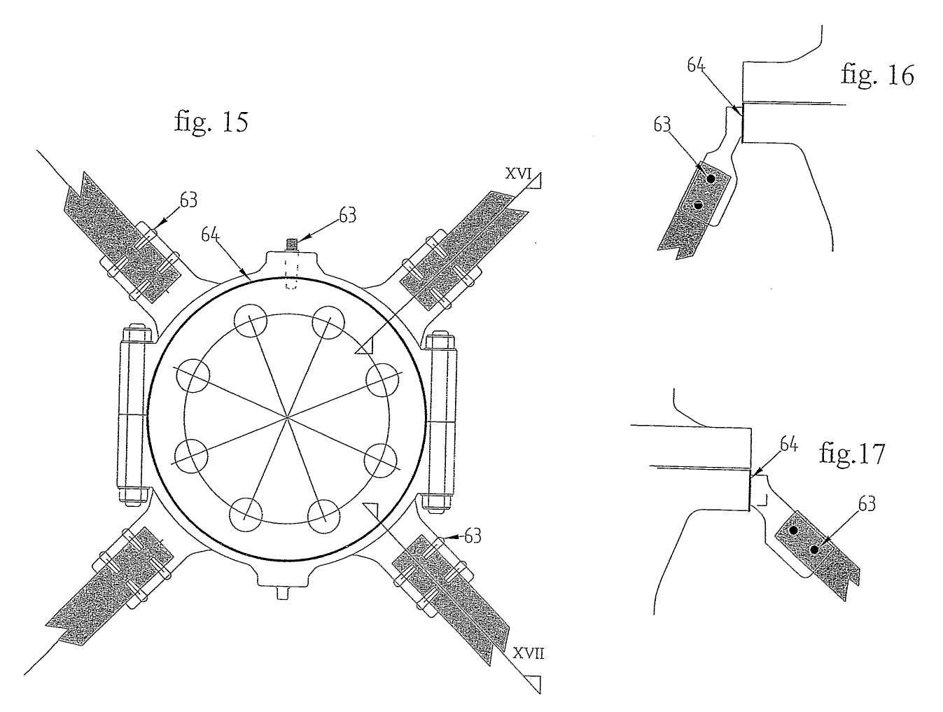

FIG. 15 shows solutions with adapters around a flange, where conical pins 63 are placed in tapered holes. In addition, glue 64 is used. FIGS. 16 and 17 are cross sections along the lines XVI and XVII respectively in FIG. 15.

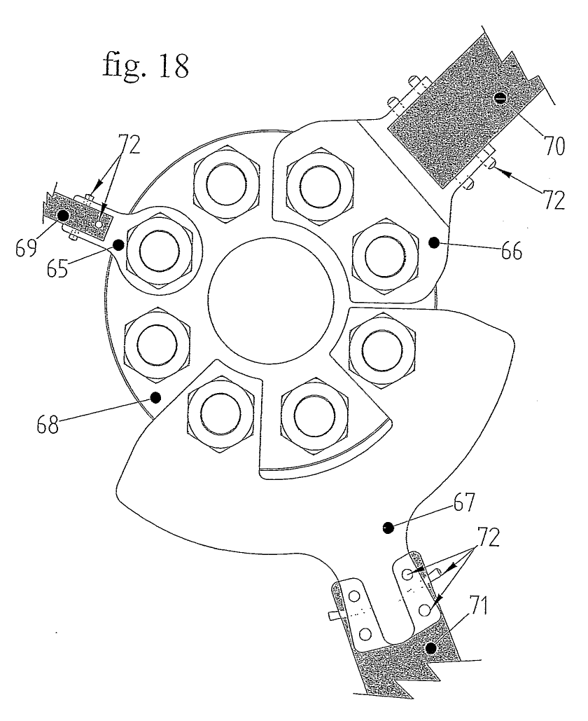

FIG. 18 shows three types of screwed adapters 65,66,67 mounted on a bolted flange 68. The damper or damper link (struts) 69-71 is fastened to the adapters with conical pins 72.

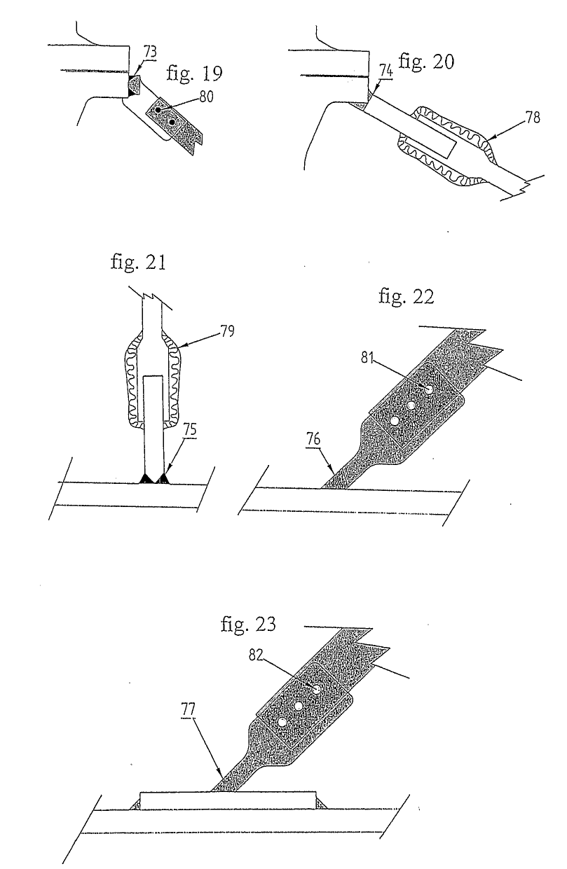

FIGS. 19 to 23 show different forms of welded joints 73,74,75,76,77 for the dampers 78,79 (only shown in FIGS. 20 and 21). Also in these arrangements the use of conical pins 80, 81 and 82 is indicated in the FIGS. 19, 22 and 23.

FIGS. 13 to 23 are only to be understood as examples of possible, preferable adapters and joints.

The invention is of course not in any way restricted to the preferred embodiments described above. On the contrary, many possibilities to modifications thereof will be apparent to a person with ordinary skill in the art without departing from the basic idea of the invention such as defined in the appended claims.

For example, two or more visco elastic damper links could be arranged in parallel or in series or any combination thereof if so desired depending on the specific oscillations to be damped out and the piping system application in question. Thus, two or more visco elastic dampers can extend in parallel and/or series between the object (pipe detail) to be damped and a support location on the piping system.

Several shear layers or sheets of visco elastic material which are fixedly bonded to the inner faces of the two plate elements (first stiff member) and the opposite faces of the end part of the strut (second stiff member) may for example also be used, instead of only one layer of visco elastic material. Further, a mixture of different visco elastic materials may be used depending on the specific oscillations to be damped out in the piping system, instead of only one kind of visco elastic material.

The above-described embodiment examples show different types of attachments of the damper or damper link to the pipe object or detail to be damped and the pipe structure. However, other types of such attachments than the one shown in these embodiment examples may alternatively well be used, for example welding, moulding, gluing, riveting or bolting, etc.

For example, the U-shaped structure comprising the two stiff plate elements may be secured together via an intermediate end element arranged between the plate elements and the end part of the strut or the like, instead of forming the U-shaped structure comprising the two plates in one single piece.

1-14. (canceled)

15. A visco elastic damping of a piping system, which system oscillates with high frequency, small amplitude oscillations, and comprises one or more autonomous visco elastic damper links of the type which comprises one or more layers of visco elastic damping material fixedly bonded between a first stiff member and a second stiff member, wherein the visco elastic damper link or damper links is/are stiffly joined between mutually connected pipe sections or pipe details within the piping system, wherein the relative displacement between said mutually connected pipe sections or pipe details, i.e. between two different parts of the piping system itself, is substantially limited.

16. The visco elastic damping according to claim 15, wherein a visco elastic damper link of the said type is arranged for damping of oscillations in the longitudinal direction of a first pipe, and wherein two visco elastic damper links of the said type are arranged for damping of oscillations across said longitudinal direction of said pipe.

17. The elastic damping according to claim 16, wherein the visco elastic damper links are stiffly attached between a main pipe and an attachment.

18. The visco elastic damping according to claim 16, wherein each one of the visco elastic damper links is connected to the respective pipes via respective struts, where the struts are connected to the pipes by means of adapters fitted to the pipes.

19. The visco elastic damping according to claim 15, wherein one or more visco elastic damper links is fastened between the pipe legs of a pipe bend.

20. The visco elastic damping according to claim 19, wherein two visco elastic damper links are arranged mutually rotated 90 degrees in the longitudinal direction.

21. The visco elastic damping according to claim 15, wherein the visco elastic damper links are arranged between a pipe and a supporting element surrounding the pipe.

22. The visco elastic damping according to claim 15, wherein the respective visco elastic damper link is provided with temperature controlling element.

23. The visco elastic damping according to claim 22, wherein the visco elastic damping material and the temperature controlling element are surrounded by an insulation layer which is encapsulated by a protective means.

24. The visco elastic damping according to claim 8, wherein the temperature controlling element is an electric heating element.

25. The visco elastic damping according to claim 22, wherein the temperature controlling element is an electric cooling element.

26. The visco elastic damping according to claim 22, wherein a temperature sensor is arranged within or in the immediate proximity of the visco elastic material.
